(19) United States
(12) Patent Application Publication
(10) Pub. No.: US 2009/0000916 A1
(43) Pub. Date: Jan. 1, 2009

(54) Aggregate Reclaimer Device and Method

(76) Inventor: Lloyd Ash, Pleasant Grove, UT (US)

Correspondence Address: THORPE NORTH & WESTERN, LLP., P.O. Box 1219, SANDY, UT, 84091-1219, US

(21) Appl. No.: 12/163,781

(22) Filed: Jun. 27, 2008

Related U.S. Application Data
(60) Provisional application No. 60/937,950, filed on Jun. 29, 2007.
(60) Provisional application No. 60/999,072, filed on Oct. 15, 2007.

(51) Int. Cl. B65G 65/00

(52) U.S. Cl. 198/508

(57) ABSTRACT

An aggregate material reclaiming device includes a base plate positionable at a substantially coplanar elevation as a support surface, and has an opening therethrough. A frame is coupled to the base plate and suspended from the base plate into a depression below the support surface. A conveyor belt is coupled to the frame below the support surface, and is positioned below the opening in the base plate. The conveyor belt receives and removes aggregate material from the opening to a remote location from the reclaiming device. At least one sliding plate is disposed on an upper surface of the base plate and is slidable from a distal end of the base plate to a position adjacent the opening. A lifting device is operably coupled to the at least one sliding plate and is operable to lift the sliding plate into an elevated position with respect to the base plate.

### PRIORITY CLAIM

Benefit is claimed of U.S. Provisional Patent Application No. 60/937,950, filed Jun. 29, 2007, and U.S. Provisional Patent Application No. 60/999,072, filed Oct. 15, 2007 which are herein incorporated by reference in their entirety for all purposes.

### BACKGROUND OF THE INVENTION

1. Field of the Invention

The present invention relates generally to aggregate material storage and reclamation and more specifically to reclaiming aggregate material from storage stacks or piles.

2. Related Art

Aggregate material, such as coal, mineral ore, gravel, sand, soil, and the like, is often stored in large stacks or piles. These piles are often formed when the aggregate material is dumped or offloaded from bulk material transport vehicles, or after the aggregate material has been processed through a feeder breaker. When the aggregate material in such stacks is needed, the material is “reclaimed” by moving the material from the stack to a conveyor belt, transport vehicle, or the like.

One common method of reclaiming aggregate material from a stack often involves the use of a dozer trap. A dozer trap usually includes a concrete catch basin into which the aggregate material can be pushed by a bull dozer. A conveyor in the bottom of the catch basin receives the aggregate material and moves the material from the catch basin to a remote dump location, such as the hopper of a transport vehicle.

Other types of reclaiming devices are also used to reclaim aggregate material from stacks. For example, bridge drag chain or drum reclaimers place the aggregate material between two raised rails and a mobile bridge, supported by the rails, skims across the top of the aggregate material reclaiming aggregate material from the top of the stack. As another example, bucket reclaimers have a bucket wheel suspended on a boom that can swing to an aggregate material stack where the bucket wheel picks up aggregate material as it rotates.

Unfortunately, these reclaiming methods and devices have limitations. For example, dozer traps push material onto a conveyor which removes the material from the bottom of the pile. It will be appreciated that many aggregate materials have enough moisture in the material such that the material can pack together. Because of this packing effect, only material directly over the conveyor is pulled or falls onto the conveyor and the material along the sides of the conveyor can form a wall along an angle of repose of the aggregate material. In this way, the material can form a bridge or chimney in the stack around or above the conveyor. Such chimneys or bridges must be knocked down by the bull dozer in order for the conveyor to continue moving material.

Additionally, drum and bucket reclaimers are limited in that they can only reclaim material the drag chain, drum, or buckets can reach on the top of the stack. As the material level falls below the bridge or outside of the reach of the bucket wheel, these top-first reclaimers must be repositioned or more aggregate material must be moved to within reach of the drum or bucket wheel in order for the reclaimer to continue to reclaim aggregate material.

### SUMMARY OF THE INVENTION

The inventor of the present invention has recognized that it would be advantageous to develop a method and device for reclaiming aggregate material that removes material from the bottom of the pile and reduces the formation of chimneys and/or bridges in the aggregate material. The inventor has also recognized that it would be advantageous to develop a method and device for reclaiming aggregate material that reduces the need for aggregate material moving equipment, such as a bull dozer, bucket wheel, or drum bridge to be moved to the aggregate material pile. Additionally, the inventor has recognized that it would be advantageous to develop a method and device for reclaiming aggregate material that reduces the need to move the aggregate material, such as by bull dozer, from a storage site to a reclaiming site.

The embodiments of the present invention described herein generally provide for an aggregate material reclaiming device. The reclaimer of the present invention can have a base plate that can be positioned at approximately ground level over a depression or excavation in the ground. The base plate can have an opening extending through the base plate such that aggregate material can fall through the opening into the depression below the base plate. A frame can be coupled to the base plate and can be suspended from the base plate into the depression or excavation. A conveyor belt can be coupled to the frame and positioned below the opening in the base plate so that aggregate material falling through the base plate will fall onto the conveyor belt. The conveyor belt can convey material out from under the base plate to a remote location away from the reclaimer. A pair of sliding plates can be slidably disposed on the base plate. The sliding plates can slide between opposite ends of the base plate and the opening. The sliding plates can move aggregate material toward the opening in the base plate when they slide from the ends of the base plate toward the opening so as to reduce the formation of chimneys or bridges in the aggregate material. A lifting device is operably coupled to the at least one sliding plate and is operable to lift the sliding plate into an elevated position with respect to the base plate.

The present invention also provides for a method for reclaiming aggregate material including piling aggregate material onto a base plate and at least one sliding plate of an aggregate material reclaiming device. The sliding plate can be slid from a distal end of the base plate to a position adjacent an opening in the base plate so as to move aggregate material toward and into the opening. A conveyor belt located below the opening can be engaged to remove aggregate material falling through the opening to a remote location away from the reclaiming device.

The present invention also provides for a method for making an aggregate material reclaiming station including excavating a relatively shallow depression in a ground support surfaced. The depression can have a depth of less than approximately 60 inches from the support surface. An integrated aggregate material reclaimer device can be placed into the depression and positioned such that a base plate of the reclaimer device is positioned at a substantially coplanar elevation as the support surface. The reclaimer device can also include an opening extending through the base plate sized and frame coupled to the base plate and suspended from the base plate into the depression below the base plate. A conveyor belt can be coupled to the frame below the base plate, and positioned below the opening in the base plate to receive and remove aggregate material from the opening to a remote location from the reclaiming device. At least one sliding plate can be disposed on an upper surface of the base plate and slidable along the upper surface between a distal end of the base plate and a position adjacent the opening.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is an elevation side view of an aggregate material reclaiming device in accordance with an embodiment of the present invention;

FIG. 2 is a top view of the reclaiming device of FIG. 1;

FIG. 3 is perspective view of the reclaiming device of FIG. 1, shown without an inclined conveyor belt extending away from at least one sliding plate;

FIG. 4 is a perspective view of the reclaiming device of FIG. 1, shown with the at least one sliding plate in an elevated or inclined position;

FIG. 5 is a cross section side view of the reclaiming device of FIG. 1, shown with a lower conveyor positionable between a lower and higher elevation;

FIG. 6 is a cross section side view of the reclaiming device of FIG. 1, shown with a plate limiter;

FIG. 7 is a top view of the reclaiming device of FIG. 1, shown without an inclined conveyor belt extending away from at least one sliding plate; and

FIG. 8 is a fragmentary cross section side view of the reclaiming device of FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein generally provide for an aggregate material reclaiming device, or “reclaimer.” It will be appreciated that aggregate material, such as coal, mineral ore, gravel, sand, soil, and the like is often stored in large piles or “stacks” of aggregate material, and in order to use the aggregate material, the material must be picked up, recovered, or reclaimed from the pile and moved to equipment, such as a hopper style transport vehicle.

Accordingly, the reclaimer of the present invention can have a base plate that can be positioned at approximately ground level over a depression or excavation in the ground. The base plate can have an opening extending through the base plate such that aggregate material can fall through the opening into the escavation below the base plate. A frame can be coupled to the base plate and can be suspended from the base plate into the depression or excavation. A conveyor belt can be coupled to the frame and positioned below the opening in the base plate so that aggregate material falling through the base plate will fall onto the conveyor belt. The conveyor belt can convey material out from under the base plate to a remote location away from the reclaimer, such as the hopper of a nearby aggregate material transport vehicle. A pair of sliding plates can be slidably disposed on the base plate. The sliding plates can slide between opposite ends of the base plate and the opening. The sliding plates can move aggregate material toward the opening in the base plate when they slide from the ends of the base plate toward the opening. In this way, the sliding plates can break up and move aggregate material from an aggregate material stack or pile on top of the base plate toward the conveyor, thereby reducing the formation of chimneys or bridges in the aggregate material.

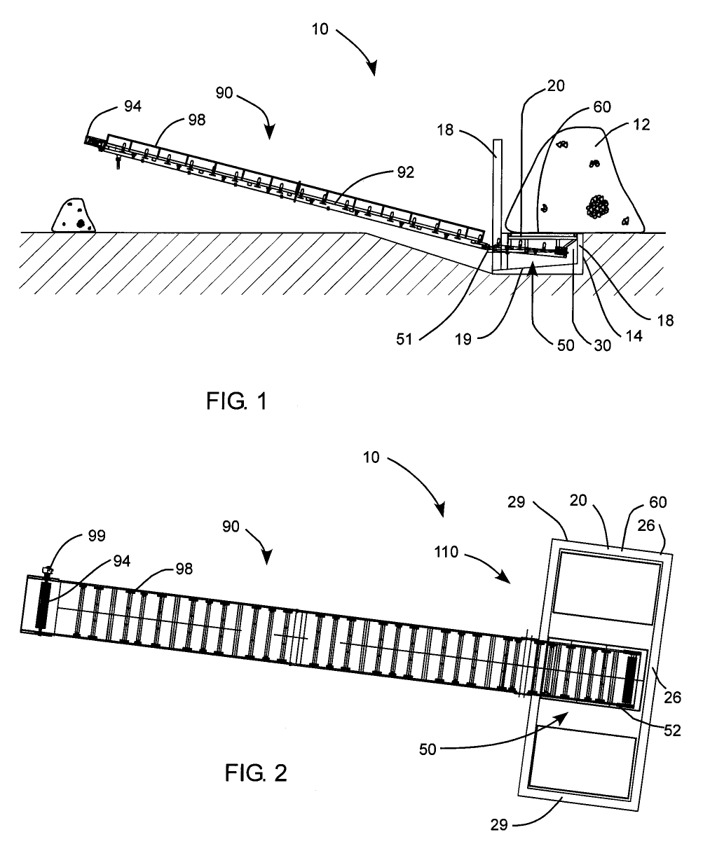

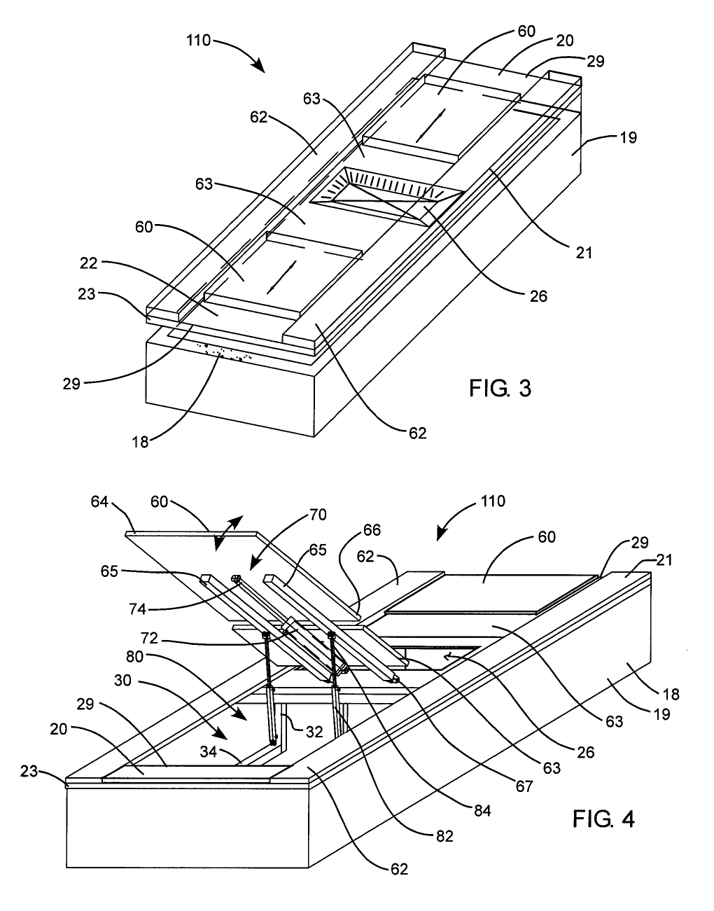

As illustrated in FIGS. 1-8, an aggregate material reclaiming device, indicated generally at 10, in accordance with an embodiment of the present invention is shown for use in reclaiming aggregate material, such as coal, mineral ore, gravel, sand, soil, and the like from a storage pile or stack 12. The aggregate material reclaiming device, or reclaimer, 10 can include a base floor plate 20, a frame, indicated generally at 30, suspended from the base plate, a lower conveyor belt, indicated generally at 50, coupled to the frame, and at least one sliding plate 60 disposed on an upper surface 22 of the base plate.

The base floor plate or base plate 20 can be a substantially flat plate having an upper surface 22 and a lower surface 24. The base plate 20 can be positioned over a depression or excavation 14 in the ground such that the upper surface of the base plate is positioned at a substantially co-planar elevation as an adjacent support surface 14. Additionally, the base plate 20 can be sized and shaped to support and carry aggregate material. In one aspect, the upper surface area can be approximately 10 feet wide by 30 feet in length for a total square foot area of about 300 square feet.

An outer peripheral edge 26 of the base plate 20 can be supported at ground level such that the base plate spans or bridges the depression 14. In one aspect, the outer peripheral edge 26 can be supported by the support surface 14. In another aspect, the outer peripheral edge 26 of the base plate 20 can be supported by a foundation, such as a footing or concrete wall 18, as shown in FIGS. 1-7. The concrete wall 18 can line the depression or excavation 14 and can be in the form of a box 19. In this way, the base plate 20 can cover the box 19 formed by the concrete wall 18.

The base plate 20 can also have a hole or opening 26 extending through the base plate. The hole 26 can be sized and shaped to allow aggregate material to pass from above the base plate 20 into the box 19 formed by the concrete wall 18 below the base plate.

The base plate 20 can be formed from a metal material such as steel. In one aspect, the base plate 20 can be formed from a hardened steel such as AR steel that can be resistant to impacts, deformation to extreme loading, and corrosion.

The frame 30 can be coupled to the lower surface 24 of the base plate 20. The frame 30 can be formed of a metal material such as steel with the various parts of the frame being fastened together by suitable fastening techniques such as welding, bolts, and the like. The frame 30 can also be suspended by the base plate 20 such that the frame extends from the lower surface 24 downward into the depression or excavation 14. The frame 30 can be formed of metal tubing, such as square steel tubing, and can include downwardly extending members 32 and longitudinally extending members 34. In one aspect, the frame 30 can strengthen the base plate 20 to support a load applied to the base plate from aggregate material piled or stacked onto the upper surface 22 of the base plate. The frame 30 can also be configured to carry or support equipment, such as the conveyor belt 50.

Referring to FIGS. 1 and 8, the lower conveyor belt 50 can be coupled to the frame 20 below the support surface. The lower conveyor belt 50 can be positioned below the opening 26 in the base plate 20. In this way, the lower conveyor belt 50 can receive aggregate material from the opening 26. The conveyor belt 50 can be similar to standard conveyor belts, known in the art. Thus, the lower conveyor belt 50 can have continuous or endless belt 52 coupled to a drive wheel 54, a tension wheel 56, and at least one idler wheel 55 disposed on an elongated frame 58. The lower conveyor belt 50 can be driven by an electrical, pneumatic, or hydraulic power supply 59 in order to remove the aggregate material to a remote location away from the reclaiming device 10.

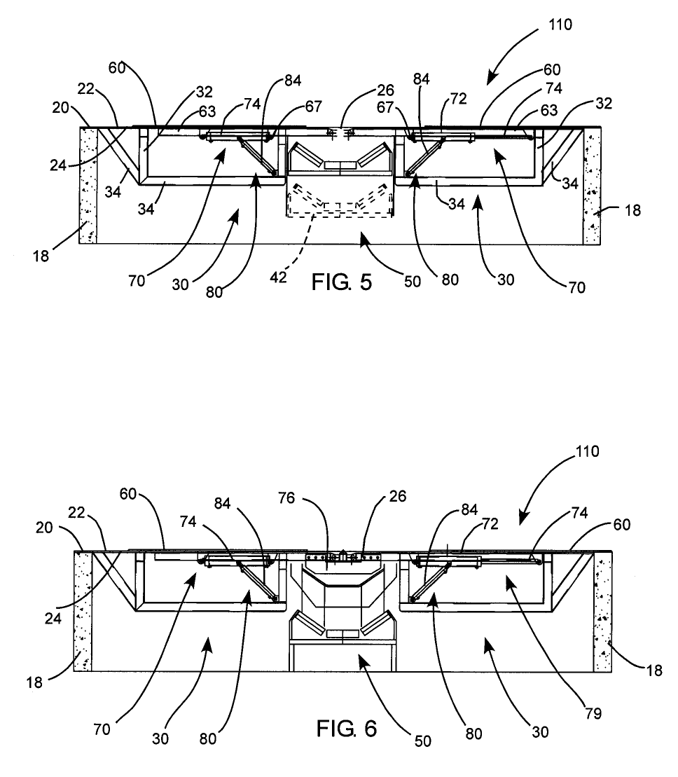

Advantageously, the elevation of the lower conveyor belt 50 can be adjusted with respect to the elevation of the base plate 20 or opening 26 in the base plate, as shown in FIG. 5. In this way, the amount of aggregate material allowed to fall through the hole 26 and onto the lower conveyor belt 50 can be increased, by moving the lower conveyor to a lower position, indicated by dashed lines at 42. Adjusting the elevation of the conveyor belt 50 in this way increases the space or elevation between the lower conveyor belt 50 and the opening 26 in the base plate 20 which in turn increases the amount of aggregate material the conveyor belt 50 can carry. Similarly, the amount of aggregate material can be decreased, by moving the lower conveyor belt 50 to a relatively higher position so as to decrease the space or elevation between the lower conveyor belt 50 and the opening 26 in the base plate 20. Thus, advantageously, the positioning of the lower conveyor 50 can be used to control the flow rate of aggregate material from the reclaimer 10.

Additionally, as shown in FIG. 6, the reclaimer 10 can also have a plate limiter or striker plate 76 coupled to the frame 20 and positioned between the opening 26 and the lower conveyor 50. The striker plate 76 can increase or decrease the area between the opening 26 in the base plate 20 and the lower conveyor 50 in order to increase or decrease the flow rate of aggregate material through the opening 26 and on the lower conveyor 50.

It will be appreciated that the flow rate of aggregate material from the reclaimer 10 can also be increased or decreased by increasing or decreasing the speed of the conveyor belts 50 of the conveyor system. Hence, a faster conveyor belt speed can increase the flow rate of aggregate material from the reclaimer. Similarly, a slower conveyor belt speed can decrease the flow rate of aggregate material from the reclaimer. Thus, advantageously, the flow rate of aggregate material from the reclaimer 10 can be changed by at least three different methods, namely, adjusting the distance between the lower conveyor belt 50 and the opening 26, adjusting the distance between the striker plate 76 and the base plate 22, and increasing or decreasing the speed of the conveyor belt 50.

Referring to FIGS. 1-2 and 8, the reclaimer 10 can also have an inclined conveyor belt, indicated generally at 90, disposed adjacent a discharge end 51 of the lower conveyor belt 50 described above. The inclined conveyor belt 90 can be oriented at an inclined angle with respect to the lower conveyor belt and the support surface. The inclined conveyor belt 90 can be being configured to receive and remove aggregate material from the lower conveyor belt 50 to a remote location from the reclaiming device 10. The inclined conveyor belt 90 can be similar to standard conveyor belts, as known in the art. Thus, the inclined conveyor belt 90 can have continuous or endless belt 92 coupled to a drive wheel 94, a tension wheel 96, and at least one idler wheel 95. The wheels and continuous belt can be disposed on an elongated frame 98. The inclined conveyor belt 90 can be driven by an electrical, pneumatic, or hydraulic power supply 99 in order to remove the aggregate material to a remote location away from the reclaimer 10.

Referring again to FIGS. 1-8, the reclaimer 10 can also have at least one sliding plate 60 disposed on the upper surface 22 of the base plate 20. The sliding plates 60 can be slidably movable along the upper surface 22 from a distal end 29 of the base plate to a position adjacent the opening 26. The sliding plates 60 can be formed of a metal such as steel. For example, the sliding plates 60 can be made of a mild steel such that the sliding plates can be sacrificially wasted with respect to the base plate 20 and the frame 30.

In one aspect, the reclaimer 10 can have a pair of sliding plates 60 with each sliding plate 60 disposed on opposite sides of the opening 26 in the base plate 20. In one aspect, each of the sliding plates 60 can slide approximately 36 inches along the upper surface 22 of the base plate 20 between the distal ends 29 and the opening 26 of the base plate 20. The sliding plates can be supported by a pair of frame beams 65. A lift plate 63 can be disposed on the frame beams 65 to help support and protect the sliding plates 60.

A guide plate 62 can extend along each longitudinal side 21 and 23 of the base plate 20. The guide plates 62 can guide the sliding plates 60 as the sliding plates move between the distal end 29 of the base plate 20 and the position adjacent the opening 26. The guide plates 62 can be formed of a structural metal material such as steel.

In use, when the sliding plates 60 move between the distal end 29 and the position adjacent the opening 26, the sliding plates can carry and move aggregate material that may be piled on top of the sliding plates. In this way, the sliding plates 60 can move aggregate material toward the opening 26 in the base plate 20. Advantageously, this sliding motion reduces the need for bull dozers to push the aggregate material onto the lower conveyor belt 50, and also allows the sliding plates 60 to break up compacted aggregate material, thereby reducing the likelihood of the formation of chimneys and bridges in the aggregate material 12 stacked on the base plate 20.

It is a particular advantage of the embodiments of the reclaimer device described herein that the sliding plates can move the stacked aggregate material in order to break up the stacked and packed formations of the aggregate material. It will be appreciated that some types of coal, such as Powder River Basin (PRB) coal have chemical properties that can cause the coal to pack together and have very steep angles of repose. Additionally, PRB coal has sufficient moisture content that the coal can easily spontaneously combust. If such spontaneous combustion occurs in the presence a chimney, the resulting fire can quickly spread and cause significant damage. Thus, the sliding plates 60 of the present invention can break up chimneys, bridges, and steep angle of repose walls that facilitate oxygenation of the coal. In this way, the present invention can advantageously reduce the risk of spontaneous combustion coal fires in the stored and stacked coal.

Referring to FIGS. 4-7, the reclaiming device 10 can also include a sliding device, indicated generally at 70, operably coupled to the sliding plates 60. The sliding device 70 can operate to slidably move the sliding plates 60 between the distal end 29 of the base plate 20 and the position adjacent the opening 26. In this way the sliding plates 60 can reciprocate or oscillate between the distal end 29 and the end 66 adjacent the opening 26. The sliding device 70 can include a cylinder 72 and a ram 74 and can be powered by a hydraulic, electric, or pneumatic power source (not shown). Thus, in one aspect, the sliding device 70 can include a hydraulic cylinder and ram. The sliding device 70 can cause the sliding plates 60 to slide at a rate of approximately 4 oscillations per minute. Additionally the sliding device 70 can slide the sliding plates 60 approximately 36 inches along the upper surface 22 of the base plate 20.

The reclaiming device 10 can also include a lifting device, indicated generally at 80. The lifting device 80 can be operably coupled to the base plate 20 and the sliding plates 60. In one aspect, the lifting device 80 can operate to lift the sliding plates 60 into an elevated and inclined position with respect to the base plate 20, as shown in FIG. 4. In this case, the lifting device 80 can lift a distal end 64 of the sliding plates 60 while the end 66 adjacent the opening 26 is pivoted about a pivot point or hinge 67 on the frame 30. In this way, the elevated position of the base plates 20 and sliding plates 60 can be at an inclined angle with respect to the opening 26 and frame 30. In another aspect (not shown), the lifting device 80 can operate to lift the base plate 20 and sliding plates 60 into an elevated position with respect to the frame 30. The sliding plates 60 can slide in both the elevated or inclined position and the non-inclined position.

Additionally, the reclaimer device 10 can include a safety support leg (not shown) that can support the base plate 20 and sliding plates 60 in the elevated or inclined position. In one aspect, the support leg can be a separate leg from the lifting device. For example, the support leg can be a telescoping leg that can be pivotally coupled between the base plate and the frame. In the raised position the support leg can be telescoped to an extended position. In the un-raised position, the support leg can be telescoped to an un-extended position. In the extended position, the safety support leg can be locked such that the leg cannot collapse to the un-extended position. For example, a pin can be placed through a hole in the support leg to secure the leg in the extended position.

Advantageously, elevating the base plate 20 provides access to the frame 30, lower conveyor 50, and other equipment suspended from the base plate 20 into the depression or excavation 14. It will be appreciated that such access can be used to provide maintenance to the equipment below the base plate 20. Additionally, the access allows cleaning of aggregate material and potentially explosive dust from the confined space in the depression.

Similar to the sliding device, the lifting device 80 can include a cylinder 82 and a ram 84 and can be powered by a hydraulic, electric, or pneumatic power source (not shown). Thus, in one aspect, the lifting device 80 can include a hydraulic cylinder and ram.

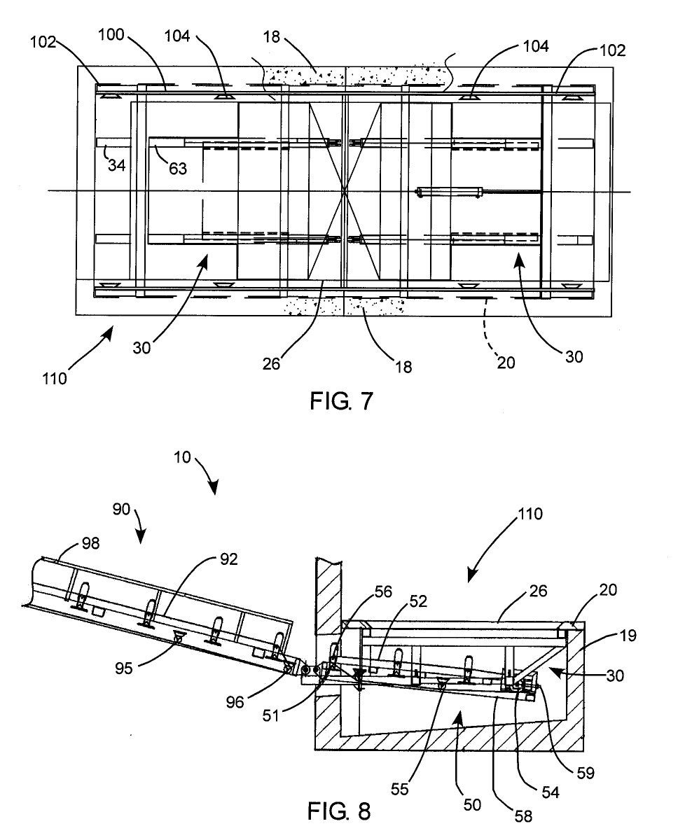

Referring to FIG. 7, the reclaiming device 10 can also include a deluge system 100. The deluge system 100 can be coupled to the frame 30 and the base plate 20. The deluge system can include pipes 102 and nozzles 104 that can direct water and other cleaning solutions to wash the reclaiming device below the base plate. Advantageously, the deluge system can wash and clean the reclaimer device 10 without removing coal from off the top of the base plate 20 and sliding plates 60. Advantageously, in this way, highly combustible coal dust can be washed away from the reclaimer without having to shut the reclaimer down for an extended period of time.

It is a particular advantage of the reclaimer device 10 can be deluged without significant down time. It will be appreciated that some types of coal, such as Powder River Basin (PRB) coal is more desirable to use because the low sulfur content of the coal. Unfortunately, PRB coal dust and, indeed any fine particulate powder, can spontaneously combust or explode if not properly cleaned. Thus, the deluge system automatically cleans the coal dust from the moving workings of the reclaimer thus reducing the chance of spontaneous combustion or explosion.

It is another particular advantage of the reclaiming device of the present invention that the base plate 20, frame 30, lower conveyor belt 50, sliding plates 60, and sliding and lifting devices 70 and 80, respectively, can be formed together as an integrated reclaimer device that is transportable and installable as a single, modular unit, indicated generally at 110. It will be appreciated that reducing assembly and construction of the reclaiming device 10 at the work site of the aggregate material during fabrication and installation of a reclaiming device can result in decreased down time of the aggregate material facility. Advantageously, reducing down time reduces lost production time and increases efficiency of the aggregate material operation.

The present invention also provides for a method for reclaiming aggregate material including piling aggregate material onto a base plate and at least one sliding plate of an aggregate material reclaiming device. The sliding plate can be slid from a distal end of the base plate to a position adjacent an opening in the base plate so as to move aggregate material toward and into the opening. A hydraulic cylinder and ram can be engaged to slide the sliding plate. A conveyor belt located below the opening can be engaged to remove aggregate material falling through the opening to a remote location away from the reclaiming device.

The method can also include lifting the sliding plate to allow access to a sliding device and the conveyor belt below the base plate. A hydraulic cylinder and ram can be engaged to lift the sliding plate. Additionally, a deluge system can be activated to wash the reclaiming device below the base plate.

The present invention also provides for a method for making an aggregate material reclaiming station including excavating a relatively shallow depression in a ground support surfaced. The depression can have a depth of less than approximately 60 inches from the support surface. An integrated aggregate material reclaimer device can be placed into the depression and positioned such that a base plate of the reclaimer device is positioned at a substantially coplanar elevation as the support surface. The reclaimer device can also include an opening extending through the base plate sized and shaped to allow aggregate material to fall therethrough into the depression below the base plate. A frame can be coupled to the base plate and suspended from the base plate into the depression below the base plate. A conveyor belt can be coupled to the frame below the base plate, and positioned below the opening in the base plate. The conveyor belt can receive and remove aggregate material from the opening to a remote location from the reclaiming device. At least one sliding plate can be disposed on an upper surface of the base plate and slidable along the upper surface between a distal end of the base plate and a position adjacent the opening. A lifting device can be operably coupled to the base plate and operable to lift the base plate into an elevated position with respect to the frame.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. An aggregate material reclaiming device, comprising:
a) a base plate positionable at a substantially coplanar elevation as a support surface, having an opening therethrough, and configured to carry aggregate material stacked thereon;
b) a frame coupled to the base plate and suspended from the base plate into a depression below the support surface;
c) a conveyor belt system coupled to the frame below the support surface, and positioned below the opening in the base plate, the conveyor belt system having a conveyor belt configured to receive aggregate material from the opening and remove the aggregate material to a remote location away from the reclaiming device; and
d) at least one sliding plate disposed on an upper surface of the base plate and slidable along the upper surface of the base plate to a position adjacent the opening, the at least one sliding plate being configured to move aggregate material toward the opening in the base plate so as to reduce the formation of chimneys and bridges in the aggregate material stacked on the base plate.

2. The device of claim 1 further comprising:
a lifting device operably coupled to the base plate and operable to lift the base plate into an elevated position with respect to the frame.

3. The device of claim 2, wherein the elevated position is at an incline with respect to the base plate opening.

4. The device of claim 2, wherein the lifting device includes a hydraulic cylinder and ram.

5. The device of claim 1, further comprising a pair of guide plates, each guide plate extending along a different longitudinal side of the base plate, and configured to guide the at least one slide plate therebetween.

6. The device of claim 1, further comprising a sliding device operably coupled to the at least one sliding plate and operable to slide the plate between the distal end of the base plate and the position adjacent the opening.

7. The device of claim 6, wherein the sliding device includes a hydraulic cylinder and ram.

8. The device of claim 1, wherein the base plate, frame, conveyor belt, at least one sliding plate, and lifting device together form an integrated reclaimer device transportable as a single unit.

9. The device of claim 1, further comprising an inclined conveyor belt disposed adjacent a discharge end of the conveyor belt positioned below the opening, the inclined conveyor belt being configured to receive and remove aggregate material from the conveyor belt to a remote location from the reclaiming device.

10. The device of claim 1, wherein the aggregate material reclaimer device is disposable in a depression below the support surface having a total depth of less than approximately 60 inches.

11. The device of claim 1, wherein a distance between the base plate and the conveyor belt is adjustable according to a desired flow rate of aggregate material.

12. The device of claim 1, further comprising a striker plate disposed between the opening and the conveyor plate to adjust the size of the opening in order to control the flow rate of aggregate material on the conveyor belt.

13. The device of claim 1, further comprising a deluge system coupled to the frame and disposed below the base plate and operable to wash the reclaiming device below the base plate.

14. An aggregate material reclaiming device, comprising:
a) a base plate positionable at a substantially coplanar elevation as a support surface, having an opening therethrough, and configured to carry aggregate material;
b) a frame coupled to the base plate and suspended from the base plate into a depression below the support surface;
c) a conveyor belt coupled to the frame below the support surface, and positioned below the opening in the base plate, the conveyor belt being configured to receive and remove aggregate material from the opening to a remote location from the reclaiming device;
d) at least one sliding plate disposed on an upper surface of the base plate and slidable along the upper surface of the base plate to a position adjacent the opening; and
c) a lifting device operably coupled to the base plate and operable to lift the base plate into an elevated position with respect to the frame.

15. The device of claim 14, wherein the elevated position is at an incline with respect to the base plate opening.

16. The device of claim 14, wherein the lifting device includes a hydraulic cylinder and ram.

17. The device of claim 14, further comprising a pair of guide plates, each guide plate extending along a different longitudinal side of the base plate, and configured to guide the at least one slide plate therebetween.

18. The device of claim 14, further comprising a sliding device operably coupled to the at least one sliding plate and operable to slide the plate between a distal end of the base plate and the position adjacent the opening, the sliding device including a hydraulic cylinder and ram.

19. The device of claim 14, wherein the base plate, frame, conveyor belt, at least one sliding plate, and lifting device together form an integrated reclaimer device transportable as a single unit.

20. The device of claim 14, further comprising an inclined conveyor belt disposed adjacent a discharge end of the conveyor belt positioned below the opening, the inclined conveyor belt being configured to receive and remove aggregate material from the conveyor belt to a remote location from the reclaiming device.

21. The device of claim 14, wherein the aggregate material reclaimer device is disposable in a below ground depression having a total depth of less than approximately 60 inches.

22. The device of claim 14, wherein a distance between the opening and the conveyor belt is adjustable according to a desired flow rate of aggregate material.

23. A method for reclaiming aggregate material, comprising:
a) piling aggregate material onto a base plate and at least one sliding plate disposed on the base plate of an aggregate material reclaiming device;
b) sliding the sliding plate along the base plate to a position adjacent an opening in the base plate so as to move aggregate material on the sliding plate toward and into the opening in the base plate; and
c) engaging a conveyor belt below the opening to remove aggregate material falling through the opening to a remote location away from the reclaiming device.

24. The method of claim 23, further comprising:
a) lifting the sliding plate to allow access to a sliding device and the conveyor belt below the base plate; and
b) activating a deluge system to wash the reclaiming device below the base plate.

25. A method for making an aggregate material reclaiming station, comprising:
a) excavating a relatively shallow depression having a depth of less than approximately 60 inches from an upper support surface;
b) positioning an integrated aggregate material reclaimer device into the depression, such that a base plate of the reclaimer device is positioned at a substantially coplanar elevation as the support surface further comprising:
i) an opening extending through the base plate sized and shaped to allow aggregate material to fall therethrough into the depression below the base plate;
ii) a frame coupled to the base plate and suspended from the base plate into the depression below the base plate;
iii) a conveyor belt coupled to the frame below the base plate, and positioned below the opening in the base plate, the conveyor belt being configured to receive and remove aggregate material from the opening to a remote location from the reclaiming device;
iv) at least one sliding plate disposed on an upper surface of the base plate and slidable along the upper surface between a distal end of the base plate and a position adjacent the opening; and
v) a lifting device operably coupled to the base plate and operable to lift the base plate into an elevated position with respect to the frame.
